(19) United States
(12) Patent Application Publication
(10) Pub. No.: US 2004/0083128 A1
(43) Pub. Date: Apr. 29, 2004

(54) Smart router for a guest room service and control system

(76) Inventors: Duane W. Buckingham, Old Lyme, CT (US); Michael Franklin, Old Lyme, CT (US); Philipp A. Roosli, Mountain Lakes, NJ (US); Tulsa A. Scott, Mystic, CT (US)

Correspondence Address: Cantor Colburn, 55 Griftin Road South, Bloomfield, CT, 06002, US

(21) Appl. No.: 10/470,109

(22) PCT Filed: Jan. 24, 2002
(86) PCT No.: PCT/US02/02354

(51) Int. Cl. G06F 17/60

(52) U.S. Cl. 705/10

(57) ABSTRACT

A method of providing guest room services and guest room control in a building including a plurality of guest rooms includes: storing in memory a plurality of addresses corresponding to a plurality of guest room control devices, each guest room control device in the plurality of guest room control devices is a centralized electronic locking system component, a guest room energy management system component, a direct digital control system component, a minibar monitoring device, or a combination comprising at least one of the foregoing guest room control devices; selecting an address of a guest room control device from the plurality of addresses; encapsulating data in a first packet configured according to a packet switching protocol; indicating in the packet the address of the guest room control device; and sending the first packet to the guest room control device through a network.

### CROSS REFERENCE TO RELATED APPLICATIONS

This application claims the benefit of U.S. Provisional Application Serial No. 60/263,940, filed Jan. 24, 2001, and to U.S. Provisional Application Serial No. 60/323,872, filed on Sep. 21, 2001, both of which are incorporated by reference herein in their entirety.

### BACKGROUND OF THE INVENTION

Energy conservation is a proven means to reduce the operating costs of hotels. But many lodging facility operators shun attempts at saving energy in the guestrooms, as they are concerned about the negative impact such measures may have on guest perception and comfort.

A modern guestroom uses approximately 25 Kilowatt-hours (KWHr) of electricity each day. Based on a cost estimate of $0.07 per KWHr, this amounts to about $1.75 per day per room. This figure assumes the following appliances are used in a typical room: Heating/Ventilation/Air-Conditioning (HVAC), Lamps (portable), Lights (fixed), Television, Radio, and Minibar. A mini-bar is a convenient store of goods within each room, usually within a refrigerator, that can be accessed by the guest at his or her discretion.

With the exception of the minibar, the appliances are manually controlled, and their daily hours of use can be reduced using an energy management system (EMS). In the case of the HVAC system, a well-designed EMS can reduce not only the number of hours the system is used each day, but can also reduce the average power required. The EMS can set back the HVAC temperature whenever a room is not rented and, when rented, whenever a guest is not in the room. The EMS will turn off lamps and lights when the guest or housekeeping leaves the room. The EMS can turn off the television when the room is not rented, and it can open or close the drapes to control heat exchange with the outside.

In modern lodging facilities, the EMS is part of a larger guest room control system, which also includes direct digital control (DDC) of the HVAC system, guestroom controls and a central electronic lock system (CELS). The guestroom controls allow a guest to remotely control the lamps, lights, drapes, television, and other appliances from a single control station. The CELS connects guestroom doorlocks to a central computer in the hotel for logging keycard access operations and for enabling and canceling access cards.

Guest room control systems are typically comprised of a control computer or device for each room. The control computer receives data from various sensors throughout the room and, in response to the feedback provided by the sensors, operates a number of remote room control devices. Such remote sensors include, for example, motion sensors, temperature sensors, smoke detectors, and door and other closure switches. Such remote room control devices include, for example, thermostats and associated relays for heating, ventilation and air conditioning (HVAC) equipment, electronic locks, lighting control switches and relays, and motors and switches for opening and closing drapes. The central control computer uses the data and control devices to, for example, adjust the room's temperature, determine and annunciate whether the room is occupied or unoccupied, determine and annunciate whether the room's mini-bar has been accessed, sound fire and emergency alarms, turn lights on or off, permit or deny access to the room, open and close drapes, turn audio-visual equipment on or off, and perform other functions related to controlling equipment or annunciating status in rooms. The central control computer located in each room can be tied to a single master central control computer. The central computer from each room provides data to the master central control computer from which such data is disseminated to display and control terminals at housekeeping, front desk, security, engineering or any number of other locations in order to provide hotel personnel with access to the data and with the ability to remotely control various room functions or settings from such terminals.

In one such guest room control system, a telephone console fitted with a touch screen acts as the control computer for the room. It obtains room temperature information from internal sensors, target temperature information from the guest through the touch screen, and room status information (rented/vacant) from the master central control computer via a twisted pair of low voltage wires connecting all of the rooms through a network structure. The control computer then decides if the various appliances in the room should be adjusted and controls the appliances by providing control signals to the appliances accordingly.

Such guest room control systems work well to provide conveniences to the guest. For example, a guest can control many functions in the guest room through a bedside telephone console. Such guest room control systems also provide convenience to housekeeping staff. For example, a housekeeper would simply refer to the screen on the master central control computer to determine if the guest room was occupied or if the minibar needs re-stocking. Moreover, guest room control systems work well to conserve energy in a guest room. However, modem guest room control systems have limitations as well. Applications that depend on a faster and unconditional link to the master central control computer, such as digital video, cannot be implemented under this architecture. To overcome this limitation, additional data lines are required to be installed. However, the installation of additional data lines in an existing hotel is expensive and increases the maintenance required for the hotel.

### SUMMARY OF THE INVENTION

The above described drawbacks and deficiencies are overcome or alleviated by a method of providing guest room services and guest room control in a building including a plurality of guest rooms. The method comprises: storing in memory a plurality of addresses corresponding to a plurality of guest room control devices, each guest room control device in the plurality of guest room control devices is a centralized electronic locking system component, a guest room energy management system component, a direct digital control system component, a minibar monitoring device, or a combination comprising at least one of the foregoing guest room control devices; selecting an address of a guest room control device from the plurality of addresses; encapsulating data in a first packet configured according to a packet switching protocol; indicating in the packet the address of the guest room control device; and sending the first packet to the guest room control device through a network.

In an alternative embodiment, a smart router for a guest room control system comprises: a first port configured to be in operable communication with a computer network; at least one processor in operable communication with the first port;

at least one memory device in operable communication with the at least one processor, the at least one memory device includes a network address table stored therein, the network address table indicates an address for a guest room control device in operable communication with the computer network, the guest room control device includes one or more of a centralized electronic locking system component, a guest room energy management system component, a direct digital control system component, and a minibar monitoring device; and wherein the at least one processor encapsulates data in a first packet configured according to a first packet switching protocol and outputs the first packet to the first port, the first packet includes a header indicating the address for the memory device.

### BRIEF DESCRIPTION OF THE DRAWINGS

Referring to the exemplary drawings wherein like elements are numbered alike in the several Figures:

FIG. 1 is a schematic diagram of a centralized guest room control system;

FIG. 2 is a block diagram depicting an external view of a smart router;

FIG. 3 is a block diagram depicting an internal view of the smart router of FIG. 2;

FIG. 4 is a schematic diagram depicting the interface of application programs and portions of operating systems in the smart router of FIG. 2; and

FIG. 5 is a network address translation table.

### DETAILED DESCRIPTION OF THE INVENTION

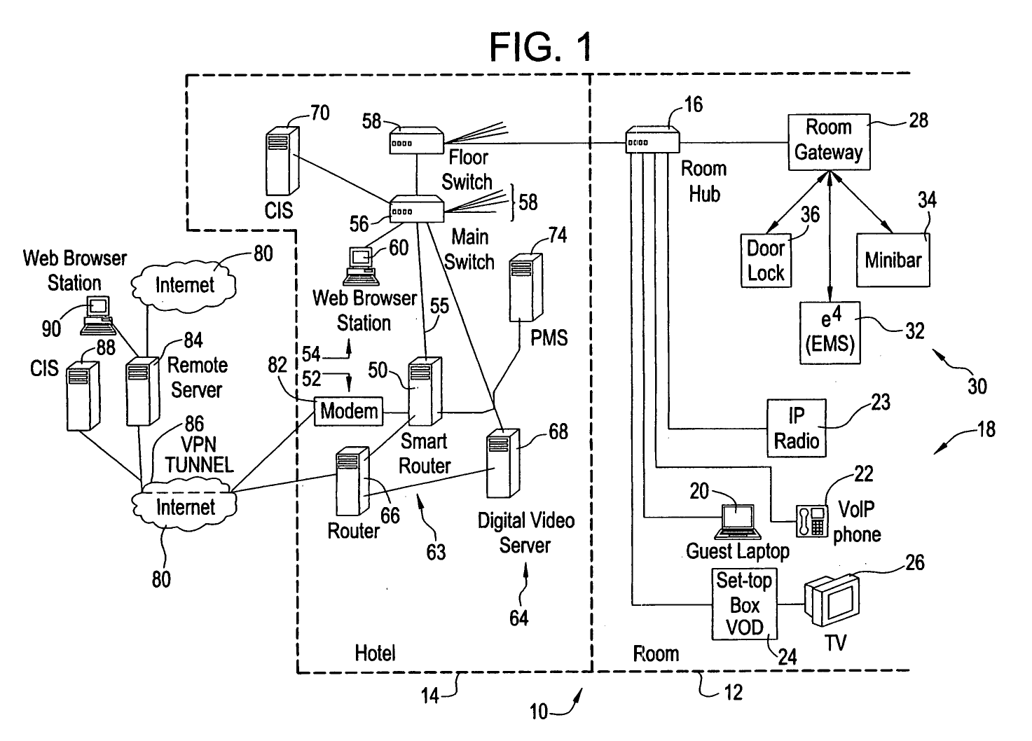

FIG. 1 depicts a centralized guest room control system or network 10 by which building-level services such as, but not limited to, digital video-on-demand, central electronic lock control, energy management, room control, and Internet access services are provided to one or more guest rooms 12 throughout one or more hotels 14 over the same network 10. While the embodiment described herein is directed to one or more hotels 14, it will be recognized that the system 10 has application in a wide range of buildings including, but not limited to, universities, health care, multi-dwelling units (MDUs), office, resort, and residential.

Guest room control system 10 is distributed across three general areas: one or more guest rooms 12, hotel 14 including the one or more guest rooms 12, and a location external to the hotel 14. It will be appreciated that the guest room control system 10 can be distributed across any number of rooms 12 in the hotel 14 and any number of buildings or hotels 14 as shown in FIG. 1.

Within each room 12, a room hub 16 coordinates communications to and from various service devices 18 within the guestroom 12. Room hub 16 is a common point of connection for the various devices 18 within guestroom 12. Room hub 16 may be a passive hub, such that when a packet arrives at one port in room hub 16, it is copied to the other ports so that all devices in the guest room can see all packets. An example of a passive hub is the commercially available Netgear® model DS 104 4-port Dual Speed (10/100) Hub. Alternatively, room hub 16 may be a switching hub that reads the destination address of each packet and then forwards the packet to the correct port. Room hub 16 may also include an intelligent hub that enables an administrator to monitor the traffic passing through the hub 16 and to configure each port in the hub 16.

Within network 10, User Datagram Protocol/Internet Protocol (UDP/IP) packets, Transport Control Protocol/Internet Protocol (TCP/IP) packets, Simple Network Management Protocol SNMP packets, Address Resolution Protocol (ARP) packets, Dynamic Host Configuration Protocol (DHCP), or the like, are passed through room hub 16 to the various guest room service devices 18. The various guest room service devices 18 may include: high-speed Internet access for a guest laptop 20; a Voice Over Internet Protocol (VoIP) phone 22 that provides the guest with phone service (e.g., a VoIP phone commercially available from Nortel); an Internet Protocol (IP) radio 23 that provides the guest with music service (e.g., a Moving Pictures Expert Group (MPEG) 1 audio layer 3 (MP3) capable radio); and a signal converter (set-top) box 24 that provides the guest with digital video-on-demand (VoD) for viewing on television 26 (e.g., model DSN-300 commercially available from Daewoo). Information to guest room service devices 18 can be transmitted within room 12 using data transmission media such as twisted-pair wire, coaxial cables, or fiber optic cables, or can be transmitted via a radio or infrared signal.

Room hub 16 also coordinates communications to and from a room gateway 28. Room gateway 28 translates the data received from room hub 16, which is formatted in packets, into a secondary protocol that may be readable by room control devices 30 in room 12. Room gateway 28 also translates the data received from room control devices 30 into a protocol (e.g., TCP/IP or UDP/IP) that can be transmitted via room hub 16. The secondary protocol is determined based on the types of room control devices 30 that are used. For example, the secondary protocol may include the IR5 infrared protocol as described in U.S. Pat. No. 5,128,792, which is incorporated by reference herein in its entirety. In another example, the secondary protocol may include Inncom International's CINET protocol, which is commercially available in Inncom International's Central Interface Networks. Other secondary protocols may include the ModBus protocol, the Bluetooth protocol, or the like.

The room control devices 30 serviced by room gateway 28 may include one or more of: an Energy Management System (EMS) device 32, a minibar monitoring device 34, a direct digital control (DDC) system device 35, and a central electronic lock system (CELS) device 36. Energy Management System (EMS) device 32 is a component in a system that digitally controls a heating, ventilation, and/or air conditioning system associated with the room 12 and which may include a digitally controlled thermostat. One example of an EMS is the e⁴™ Energy Management System commercially available from Inncom International, Inc. of Niantic, Conn. Minibar monitoring device 34, is a device that indicates when the minibar in room 12 has been accessed and may indicate which consumable items have been removed. One example of a minibar monitoring device 34 is a minibar door switch such as a model S441 door switch commercially available from Inncom International, Inc; another example is a minibar with built in monitoring capabilities commercially available from Bartech Systems Corporation of Millersville, Md. Direct digital control (DDC) system device 35 is a component in a system that allows a guest to remotely control lamps and lights, window draperies, television, or other appliances. DDC device 35 may include, for example: a model L207 lamp control module commercially available from Inncom International, Inc; a motorized window drapery system such as those commercially available from the Makita, BTX, or Silent Gliss companies; an infrared television remote control; and a model P463 Do Not Disturb/Make Up Room plate commercially available from Inncom International, Inc. A central electronic lock system (CELS) device 36 is a component in a system for locking and unlocking an access door to room 12. CELS device 36 may include, for example, a model K294 Infrared Transciever, which is commercially available from Inncom International, Inc., and infrared capable guest room door locks commercially available from such companies as TimeLox, Sargent, Safelok, and VingCard.

Inside hotel 14, guest room control system 10 is divided by a smart router 50 into two sub-networks: a primary network 52 and a secondary network 54. Secondary network 54 includes a local area network (LAN) 55 employing the Ethernet protocol for transferring data encapsulated in packets. LAN 55 includes a main switch 56 that filters and forwards packets between one or more floor switches 58. Floor switches 58 filter and forward packets between one or more room hubs 16 on a floor of hotel 14.

Secondary network 54 includes a commercially available property management system (PMS) server 74 connected serially or via the Ethernet to smart router 50. PMS server 74 may include, for example, the Micros® Fidelio OPERA PMS, which is commercially available from Micros Systems, Inc. of Columbia, Md. PMS server 74 stores, processes, and recalls room usage information (i.e., whether the room is rented or vacant) and room billing information for lodging fees, Internet access, video-on-demand, mini-bar usage and other services. PMS server 74 transmits room status information to and accepts billing information from smart router 50.

Secondary network 54 also includes a web browser station 60, which is a personal computer connected to a port of main switch 56. Web browser station 60 allows hotel personnel to access hotel information. The station 60 uses a browser to provide indication on rented status, room occupancy, minibar service, do-not-disturb (DND) and make-up-room) requests, diagnostics and other data. Engineering or management personnel will be able to see information on energy management performance, diagnostic alerts and other useful items. A central interface server (CIS) 70 is also provided, which stores, processes, and recalls guestroom control signals to augment on-site capability. One example of a CIS 70 is Inncom International's commercially available CIS-5 22058 Central Interface Server.

Primary network 52 includes a LAN 63 employing the Ethernet protocol for transferring data encapsulated in packets. LAN 63 includes one or more information servers 64 and a router 66. Information servers 64 store, process, and retrieve data typically used in the operation of a modern hotel system. Information servers 64 include a digital video server 68, which stores, processes, and recalls digital video programming for viewing on television 26. While digital video server 68 is shown, it will be recognized that primary network 52 may include other information servers as well.

Router 66 connects primary network 52 with the Internet 80. Router 66 receives TCP/IP packets from the Internet 80 and uses packet headers and a forwarding table stored within router 66 to direct the packets to smart router 50 or digital video server 68. Router 66 also provides firewall and security services for the primary and secondary networks 52, 54. In addition to router 66, a modem 82 connects primary network 52 with the Internet 80 via smart router 50, and smart router 50 provides a firewall and security services for the primary and secondary networks 52, 54.

Outside hotel 14, all hotel data, including the hotel's in-house Internet homepage, are stored and maintained on a remote server 84. Remote server 84 is connected to the Internet 80, and a connection between the remote server 84 and router 66 in hotel 14 is maintained via a Virtual Private Network (VPN) Tunnel 86. All Internet traffic coming from router 66 or modem 82 in hotel 14 is automatically directed to remote server 84 through Virtual Private Network (VPN) 86. A CIS 88 is located outside hotel 14 and communicates with primary system 52 via VPN 86 and router 66. By placing CIS 88 at a remote site, CIS 88 can store, process, and recall control signals for legacy guest room control systems in any number of hotels 14. The remote CIS 88 can replace or supplement server 68 in hotel 14.

Because all Internet traffic to and from hotel 14 traverses VPN 86 to remote server 84, remote server 84 can act as a portal for internet traffic to and from guest laptop 20. For each guest laptop 20, remote server 84 provides access to certain Hypertext Markup Language (HTML) pages stored in remote server 84 (e.g., the hotel's homepage, local information, and advertiser pages) free of charge. As a result, the remote server 84 offers possibilities for selling advertising, demographic data, and other services, which can be displayed on the HTML pages available to the guest. In addition, once the guest has agreed to a high-speed Internet access charge (unless the property offers Internet access free of charge), remote server 84 allows guest laptop 20 to have unrestricted access to the Internet 80 via VPN 86 and remote server 84. Remote server 84 achieves this Internet portal function in conjunction with smart router 50. Smart router 50 monitors the secondary network 54 for guests' laptops 20, assigns a local IP address to those laptops 20, and dynamically adapts to the network and mail settings of those laptops 20. This feature allows guests to access guest room control system 10 without having to reconfigure their laptops 20. Remote server 84 filters traffic to and from the local EP addresses, and passes only those TCP/IP packets addressed to, or sent from, the IP address of those guests that have agreed to the access charge, or have been given access free of charge.

Filtering of the TCP/IP packets may also be accomplished by assigning an available bandwidth to each laptop 20, where higher priority packets (e.g., packets sent from a guest that has paid a fee for premium access) are given greater bandwidth, and lower priority packets (e.g., free services) are given less bandwidth. This bandwidth can be based on, for example, Quality of Service (QoS) attributes indicated in the headers of packets provided to, or sent from, each laptop 20. For packets sent from each laptop 20, smart router 20 may review the QoS attributes of the packets and give priority to those packets having a higher priority QoS. Conversely, smart router 20 may review the QoS attributes of the packets sent from each laptop 20 and drop or queue (delay) those packets with a lower priority QoS. For packets sent to each laptop 20, remote server 84 may review the QoS attributes of the packets and give priority to those packets having a higher priority QoS. Conversely, remote server 84 may review the QoS attributes of the packets sent from each laptop 20 and drop or queue (delay) those packets with a lower priority QoS. Using both the smart router 20 and remote server 84 to filter packets reduces traffic in VPN Tunnel 86.

Smart router 50 periodically connects through modem 82 and VPN 86 to the remote server 84. Through these connections, smart router 50 off-loads collected hotel and guest information to the remote server 84. This information can be monitored using a browser station 90 connected with the remote server 84. In addition, remote server 84 provides this information back to the hotel 14, via router 66 and VPN 86, where the information can be viewed through browser station 60. In this manner, a single user can view the status of any number of hotels 14 or hotel rooms 12 from a single location (e.g., browser station 60 or browser station 90).

Remote server 84 also connects with smart router 50 to upload data from remote server 84 to smart router 50. Smart router 50 will then direct the data to the PMS server 74 or to the appropriate floor, room, and appliance. In this manner, a single user can alter the state of the PMS or any appliance in any room from a remote location.

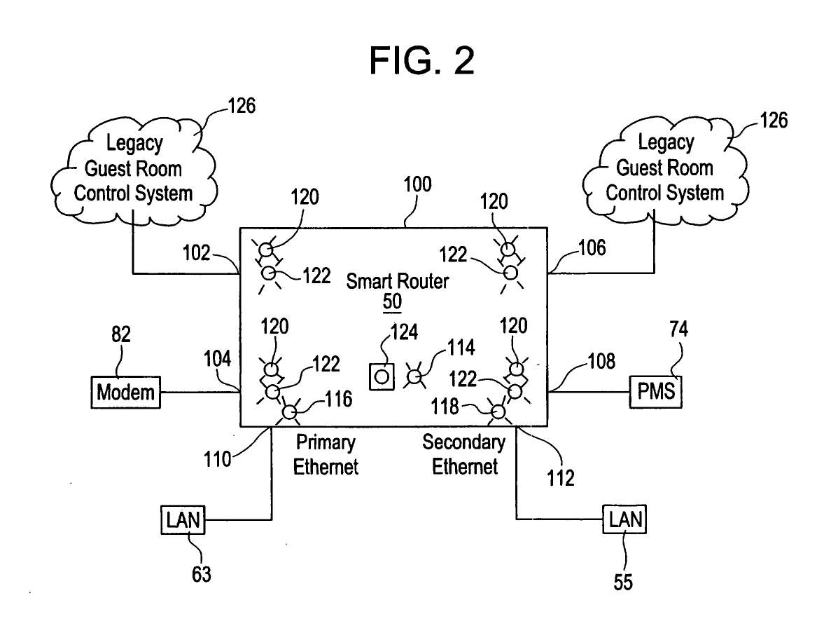

Referring now to FIG. 2, a block diagram depicting an external view of smart router 50 is shown. Smart router 50 is housed in a rack mountable chassis 100 that includes four serial ports 102, 104, 106, and 108 and two Ethernet ports 110 and 112. The smart router 50 includes light emitting diodes (LEDs) to indicate the following: power-on (LED 114), traffic on primary Ethernet port 110 (LED 116), traffic on secondary Ethernet port 112 (LED 118), traffic on RS-232 port of serial ports 102, 104, 106, and 108 (LEDs 120), and traffic on RS-485 port of serial ports 102, 104, 106, and 108 (LEDs 122). The smart router 50 also includes a push button 124 for instant connection to remote server 84 (FIG. 1). Push button 124 allows a service technician to off-load data instantly to the remote server 84 during tests and debugging phases, without having to wait for the next scheduled data off-load.

Ethernet port 110 is connected to LAN 63 of primary network 52, and Ethernet port 112 is connected to LAN 55 of secondary network 54. Serial port 104 is connected to modem 82, and serial port 108 is connected to PMS 74. Serial ports 102 and 106 allow smart router 50 to act as a replacement to a network bridge, such as the B271 riser bridge commercially available from Inncom International, Inc., in a legacy guest room control system 126.

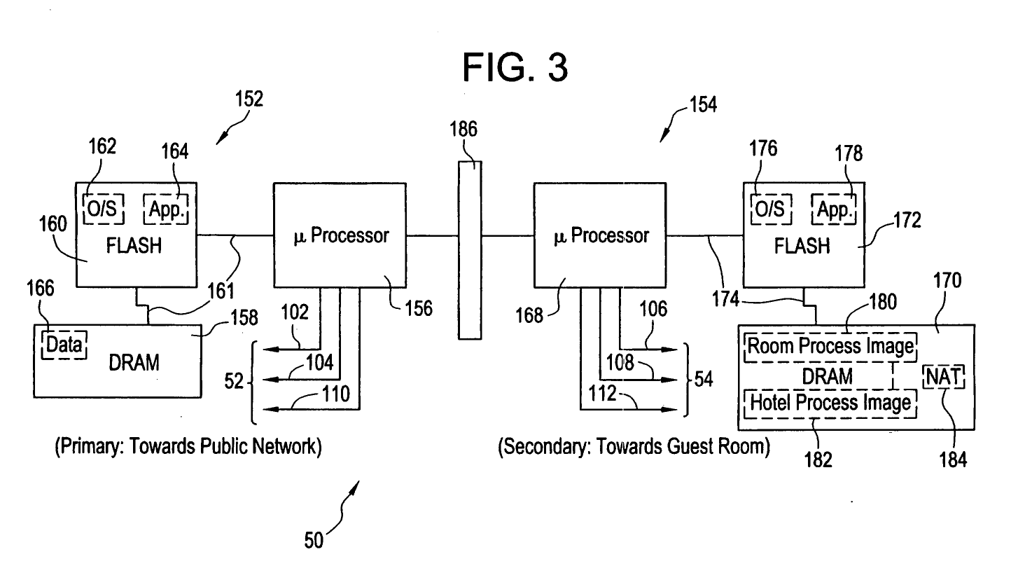

Referring to FIG. 3, a block diagram depicting an internal view of smart router 50 is shown. Smart router 50 includes two processing systems 152 and 154. Processing system 152 processes data received from and provided to primary network 52, and processing system 154 processes data received from and provided to secondary network 54. Primary network processing system 152 includes a microprocessor 156, dynamic random access memory (DRAM) 158, and flash memory 160 interconnected by a bus 161. Stored in flash memory 160 and accessed by microprocessor 156 via DRAM 158 and bus 161 is an operating system program 162 and a primary side smart application program 164. Stored in DRAM 158 is a first-in first-out queue 166 of data for off-loading to remote server 84, as will be described in further detail hereinafter. Secondary network processing system 154 includes a microprocessor 168, DRAM 170, and flash memory 172 interconnected by a bus 174. Stored in flash memory 172 and accessed by microprocessor 168 via DRAM 170 and bus 174 is an operating system program 176 and a secondary side smart application program 178. Stored in DRAM 170 are one or more room process database images 180, a hotel process database image 182, and a network address translation (NAT) table 184, as will be described in further detail hereinafter.

Microprocessors 156 and 168 operate independently of each other and share information via an interface device 186. Processors 156, 168 and interface device 186 are commercially available from Net Silicon, Inc. of Waltham, Mass. Microprocessor 156 is connected to serial ports 102 and 104 and to Ethernet port 110. Microprocessor 168 is connected to serial ports 106 and 108 and to Ethernet port 112. In general, microprocessors 156 and 168 execute applications 164 and 178, which instruct microprocessors 156 and 168 to perform various steps necessary to off-load data stored in queue 166 to remote server 84 (FIG. 1) and to route and to track all data transferred between devices 18 and 30 in guest rooms 12 and PMS server 74, remote server 84, CIS 70 and/or CIS 88, and digital video server 68.

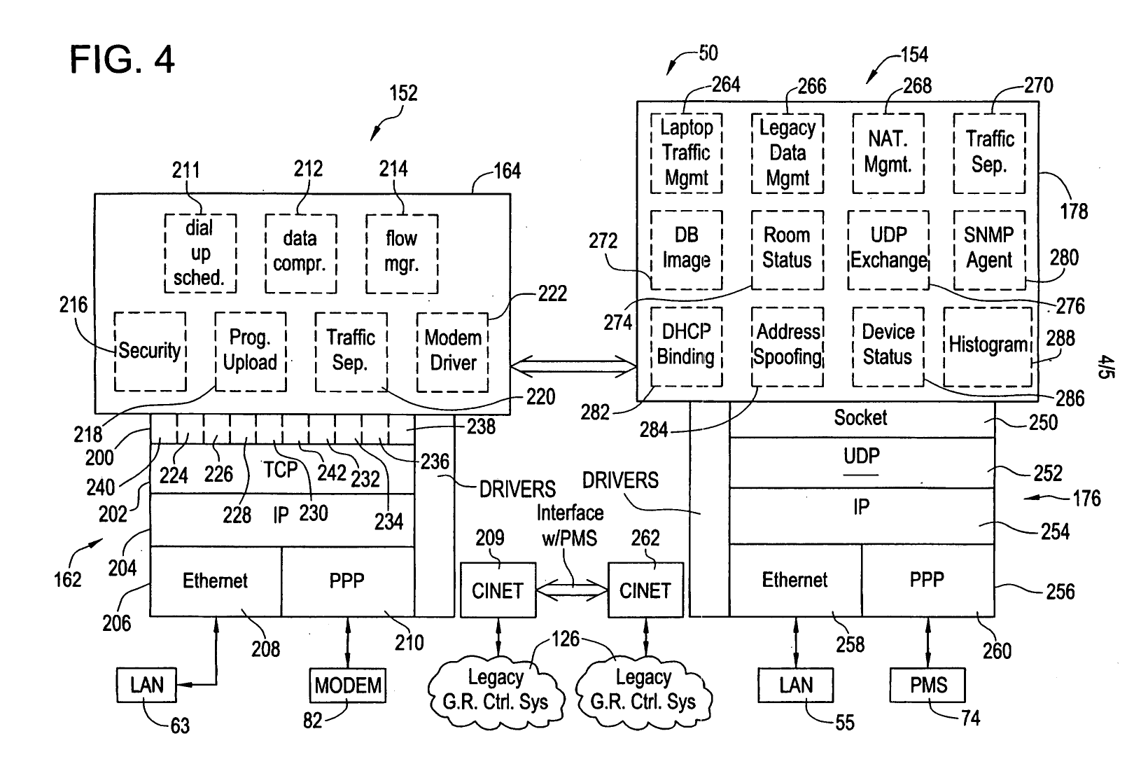

FIG. 4 is a schematic diagram depicting the interface of smart application programs 164 and 178 and portions of operating systems 162 and 176 in primary and secondary network processing systems 152 and 154, respectively. Operating systems 162 and 176 each include a stack of protocol layers, with each layer representing a process or group of processes that perform related communications tasks according to a communications protocol. In one embodiment of primary network processing system 152, the stack of layers 200, 202, 204, and 206 is known as the Transport Control Protocol/Internet Protocol (TCP/IP) stack. Processes in each layer 200, 202, 204, and 206 can call on, or be called by processes in adjacent layers 200, 202, 204 or 206, or by application 164. Layer 200 is the sockets layer; layer 202 is the TCP layer; layer 204 is the IP layer; and layer 206 is the network layer. Network layer 206 includes a process or group of processes 208 that perform communications tasks according to the Ethernet protocol for communication with LAN 63. Network layer 206 also includes a process or group of processes 210 that perform communications tasks according to the Point-to-Point Protocol (PPP) for communication with modem 82. The functions of the processes in the various layers 200, 202, 204, and 206 of the TCP/IP stack are well known in the art. Operating system 162 also includes various device drivers and a network layer process 208 for handling network layer protocols (e.g., the CINET protocol used in Inncom International Inc. commercially available guest room control systems) used in legacy guest room control system 126.

Application 164 includes processes to perform various functions. These processes include: a dial-up scheduler process 211, a data compression and elimination process 212, a flow management process 214, a security process 216, a program upload process 218, a traffic separation process 220, and a modem driver process 222. Dial-up scheduler process 211 periodically initiates a connection between the smart router 50 and the remote server 84. Dial up scheduler process 211 activates modem driver process 222, which dials a local Internet service provider (not shown). Dial up scheduler process 211 then initiates a data off-load through a file transfer protocol (FTP) link towards the remote server 84.

Data compression and elimination process 212 compresses data prior to placing the data in queue 166 to increase the amount of data that can be buffered in DRAM 158 and to reduce the chances of data congestion and bottleneck. Security process 216 provides a basic level of encryption on the data packets that leave the smart router 50 to ensure that the data is secure from inside or outside intrusion. Program upload process 218 allows application 164 in the primary network processing system 152 to be replaced on the fly by downloading new code into the flash memory 160.

Traffic separation process 220 identifies the data destined for the room devices 18 or 30, room gateway 28, PMS 74, Internet 80, etc. by monitoring data provided by a set of socket servers in sockets layer 200, as will be described in further detail hereinafter. After the data has been identified, the traffic separation process 220 directs the data to its appropriate destination. Flow management process 214 ensures that the traffic is directed in an efficient and organized fashion by delaying the transmission of certain data while expediting the transmission of other data based on such factors as data criticality and expected delays.

Sockets layer 200 includes a plurality of socket servers. Each socket server in sockets layer 200 is assigned to establish an assigned port for data from the TCP layer of the TCP/IP stack, and to handle data sent to that port. In addition, each socket server provides a basic security feature. The following TCP/IP sockets servers are found in sockets layer 200: socket server 224 for PMS 74, socket server 226 for an INNCOM or third-party peak-demand monitoring system (not shown), socket server 228 for remote server 84, socket server 230 for ISP gateway (e.g., remote server 84), socket server 232 for other third-party servers (not shown), socket server 234 for CIS 70 or 88, socket server 236 for configuration, and a socket server 238 for network address table (NAT) 184 management. Socket server 224 for PMS 74 ensures connectivity to PMS 74. PMS 74 uses the link established by socket server 224 to send room status information (e.g., occupied/vacant) to smart router 50.

Socket server 226 for an INNCOM or third party peak-demand monitoring system ensures connectivity to EMS 32. EMS 32 uses the link established by socket server 226 to send information such as outside temperature, humidity, etc. to the smart router 50. Socket server 228 for remote server 84 ensures connectivity to the remote server 84. The smart router 50 uses the link established by socket server 228 to offload data from queue 166 to the remote server 84. The socket server 230 for ISP gateway ensures connectivity to the ISP gateway server, which is the remote server 84 in the present embodiment. The socket server 232 for other third-party servers ensures connectivity to any other servers. The socket server 234 for CIS 70 ensures connectivity to CIS 70. Smart router 50 uses the link established by socket server 234 to transfer any legacy data (e.g., a CINET frame) received by the smart router 50 to the CIS 70. Correspondingly, room gateway 28 requests from the CIS 70 are routed towards the devices 30 serviced by room gateway 28, and device 30 responses are routed to the CIS 70. The socket server 236 for configuration is opened to set or change various data in flash memory 160 or 172 of smart router 50. The socket server 238 for NAT 184 management allows remote access to NAT 184.

In addition to TCP/IP socket servers 224-238, sockets layer 200 includes an FTP server 240 for downloading changes to application 164 or 178 stored in flash memory 160 or 172, and a Simple Network Management Protocol (SNMP) agent 242 for use in remotely setting Ethernet switches 56 and 58 in LAN 55.

In an embodiment of secondary network system 154, a stack of layers 250, 252, 254, and 256 is known as the User Datagram Protocol/Internet Protocol (UDP/IP) stack. Processes in each layer 250, 252, 254, and 256 can call on, or be called by processes 250, 252, 254, or 256 in adjacent layers or by application 178. Layer 250 is the sockets layer; layer 252 is the UDP layer; layer 254 is the IP layer; and layer 256 is the network layer. Network layer 256 includes a process or group of processes 258 that perform communications tasks according to the Ethernet protocol for communication with LAN 55. Network layer 256 also includes a process or group of processes 260 that perform communications tasks according to the Point-to-Point Protocol (PPP) for communication with PMS server 74. The functions of the processes in the various layers 250, 252, 254, and 256 of the UDP/IP stack are well known in the art. Operating system 176 also includes various device drivers and a network layer process 262 for handling network layer protocols (e.g., the CINET protocol used in Inncom International Inc. commercially available guest room control systems) used in legacy guest room control system 126.

Application 178 in the secondary network system includes processes 264-288 to perform various functions. Process 264 is a laptop traffic management process, which allows microprocessor 168 to manage any traffic from guest laptop 20. Process 266 is a legacy data management process, which allows microprocessor 168 to manage all of the legacy data (e.g., CINET frames) received on the secondary Ethernet port 112 (i.e., via LAN 55). Process 268 is a NAT management process, which allows microprocessor 168 to read and write from NAT 184. Process 270 routes traffic to and from the various room devices 18 and 30. Process 272 is a database image creation process that updates the room process image 180 every time the smart router 50 receives information from the room devices 18 and 30. Process 274 collects information from the PMS 74 and the room devices 18 and 30 about the status of the rooms (e.g., rented or vacant). A UDP exchange process 276 receives UDP packets from the room gateway 28, decodes the packets and routes the packets to the primary network processing system 152. Process 280 acts as a Simple Network Management Protocol (SNMP) agent for remote setup and maintenance of switches 56 and 58. Processes 282 and 284 allow for automatic configuration of guest laptop 20, where process 282 provides Dynamic Host Configuration Protocol (DHCP) binding of dynamically configured laptops 20, and process 284 provides address spoofing of statically configured laptops 20. In the former case, microprocessor 168 will act as the DHCP server, and mapped IP addresses will be provided by the ISP gateway (e.g., remote server 84). Process 286 provides information on the various devices 18 and 30 connected to the secondary network 54, such as device type, connection status, and quality of connection. Process 288 provides a histogram of traffic in the secondary network 54.

As can be seen in FIG. 4, data communication between LAN 63 or modem 82 and LAN 55 or PMS 74 is accomplished at the application levels of primary and secondary network processing systems 152 and 154. That is, data communication between LAN 63 or modem 82 and LAN 55 or PMS 74 is handled by applications 164 and 178. As can also be seen in FIG. 4, data communication between portions of legacy guest room control system 126 is accomplished between network layers processes 209 and 262. In other words, smart router 50 acts as a network layer bridge between portions of legacy guest room control system 126.

With reference to FIGS. 1 through 4, the functionality of guest room control system 10 and smart router 50 can now be described. Communication between smart router 50 and devices 30 via room gateway 28 is performed using a series of query and reply frames (packets) using UDP as the link protocol. Each frame includes a frame header containing addressing information for a specific room gateway 28 and a specific device 30, a frame sequence number, a control flag that can disable a reply to the frame, and a field that defines the type of the frame (e.g., query by smart router 50, query by room gateway 28, response by smart router 50, or response by room gateway 28).

Smart router 50 can off-load data to a device 30 via room gateway 28 by using a series of query frames with their control flags set to disable any reply. For example, when a guest checks in to hotel 14, a desk clerk enters guest information into a terminal (not shown) connected to PMS server 74. The guest information is stored as a record in the PMS server 74, and the PMS server 74 provides the data to smart router 50 via serial port 108. Room status process 274 receives the data via sockets layer 250, stores the data in non-volatile memory, and initiates the transfer of room status data to EMS 32 by calling traffic separation process 270. Traffic separation process 270 establishes a link with room gateway 28 over LAN 55 and sends frames containing the room status information to the room gateway 28 via LAN 55. Room gateway 28 strips the header from the frame and determines the destination of the device 30. Room gateway 28 then converts the data from the packet into a protocol understood by EMS 32 (e.g., Inncom International's IR5 protocol as described in U.S. Pat. No. 5,128,792). EMS 32 accepts the data and acts according to preprogrammed, rented-status logic. For example, EMS 32 may switch the room heating or air conditioning system from an energy savings mode to a guest comfort mode. Room status process 274 periodically resends room status data to EMS 32. Upon the guest's check out, the process is repeated with PMS providing the guest information to the smart router 50, and room status process 274 providing the room status data to EMS 32. EMS 32 accepts the data and acts according to its pre-programmed, vacant-status logic. For example, EMS 32 may switch the heating or air condition system from the guest comfort mode to an energy savings mode.

Where smart router 50 requires a reply from device 30, smart router 50 can query a device 30 via room gateway 28 using one or more frames having their control flags set to enable a response. Upon receiving these frames, room gateway 28 will strip the header from the frame and send the data to the appropriate device 30. Room gateway 28 saves the frame sequence number in anticipation of the response. Upon response from the device 30, room gateway 28 encapsulates the response data within a frame and includes the frame sequence number in the appropriate field. Upon receiving the frame, smart router 50 identifies the response using the frame sequence number and processes the response data from the frame.

Devices 30 may be configured to provide an event message in response to some event within room 12. An event message may include the opening of a door to minibar 34 or operation of door lock 36 by someone in guest room 12, for example. Upon receiving such an event message, room gateway 28 encapsulates the event message into one or more frames. Each frame includes addressing information from the device 30. Room gateway 28 sends the frames to smart router 50, which uses the addressing information to determine the origin and appropriate response to the event message.

The query and reply frames are also used to synchronize data stored in smart router 50 and room gateway 28. Synchronization is performed periodically, as initiated by the room status process 274 in smart router 50. Room status process 274 initiates a query containing a number of attributes (parameters) that impact on the operation of guest room 12. These parameters are retrieved from the room process image 180 for the particular room 12 and from the hotel process image 182 for the hotel 18. The parameters include, for example: rented status of the room, outside temperature, water temperature in the HVAC supply piping, system-wide energy demand situation, fire condition (i.e., if a fire alarm has been activated), central HVAC settings, and date and time. Data in the query frames are translated by room gateway 28 and provided to devices 30, which use the data to configure room control settings. In response to these query frames, devices 30 provide data to room gateway 28, which, in turn, provides one or more reply frames to smart router 50. The reply frames contain a number of attributes that indicate status information from the guest room 12. These parameters include, for example: occupancy status (i.e., if the room is unoccupied or occupied by the guest or by staff), do not disturb (if indicated by the guest), make up room (if indicated by the guest), butler request (if indicated by the guest), balcony door open/closed, entry door open/closed, room temperature, target temperature, air conditioning mode (e.g., off, fan only, auto), air conditioning fan speed, heat valve percentage open, cooling valve percentage open, and electric heater relays activated. Upon receiving the response frames, room status process 274 updates the room process image 180 for the room 12.

Hotel process image 182 is updated by input from PMS server 74. Hotel process image 182 includes hotel-wide information such as outside temperature, water temperature in the HVAC supply piping, system-wide energy demand situation, fire condition (i.e., if a fire alarm has been activated), and central HVAC settings. In addition, the information in hotel process image 182 can be changed remotely from remote server 84 via VPN 86 router 66 and LAN 63. Remote changing of hotel-wide information, in conjunction with the synchronization process described above, allows an operator at web browser station 90 attached to remote server 84 to alter the configuration of devices 30 in one or more hotels 14. This feature is particularly important for a remote server 84 that services a number of hotels 14. In this case, remote server 84, by changing the system-wide energy demand situation setting, can change the power consumption in hundreds or thousands of rooms 12 simultaneously. In effect, remote server 84 aggregates these rooms 12 into a single power consumer. As a single power consumer, the operator of remote server 84 can negotiate with electric utility companies for better power rates in exchange for promising to lower power consumption during peak demand times.

Data from hotel process image 182 and one or more room process images 182 are periodically provided by microprocessor 168 in secondary network processing system 154 to microprocessor 156 in primary network processing system 152. This data is then stored in FIFO queue 166. If the smart router is constantly connected to remote server 84 through LAN 63, router 66 and VPN 86, the data is sent immediately to remote server 84. If the connection is of the dial-up type, smart router 50 periodically establishes a connection with remote server 84 via modem 82 and VPN 86. This data can be viewed through web browser station 90.

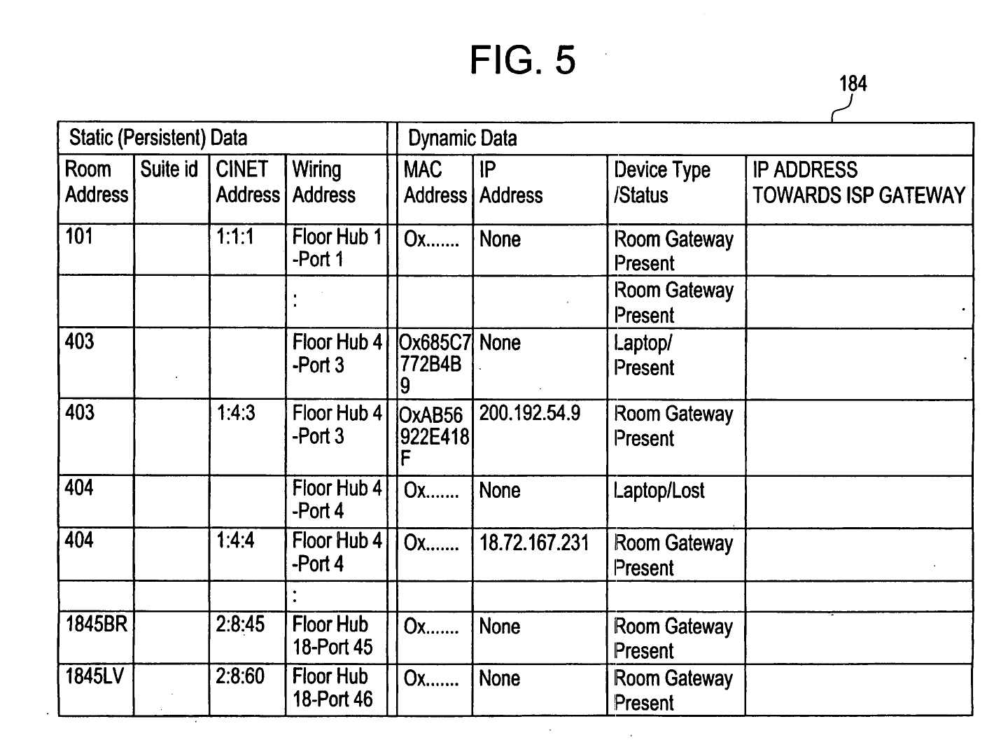

In addition to receiving off-loaded data from smart router 50, remote server 84 is able to provide data to any individual device 18 or 30 in room 12. To accomplish data transfer to devices 18 or 30, remote server 84, smart router 50 and other information servers 64 are provided with a network address translation (NAT) table 184 such as that shown in FIG. 5.

Referring to FIG. 5, NAT table 184 is a mix of static (persistent) data and dynamically acquired data. In NAT table 184, “Room Address” is the logical room number, which is used as the real address for applications. “Wiring Address” indicates the port number of the floor switch (hub) 58 to which the room hub 16 attached. “Suite ID” indicates a grouping of room hubs 16 for servicing a guest suite. “CINET Address” indicates an address for a legacy guest room control system. “MAC Address” indicates a medium access control address assigned to a specific device 18 or room gateway 28 in room 12. “IP Address” indicates an Internet protocol address for a device 18 or room gateway 28 (or an application in device 18). “Device Type/Status” identifies the device 18 or room gateway 28 and indicates whether the device 18 or room gateway 28 is present on the network. “IP Address Towards ISP Gateway” indicates an IP address for use by a guest laptop 20 (FIG. 1) for Internet access. The IP address in this field is generated by the ISP gateway (e.g., remote server 84 of FIG. 1) where process 282 (FIG. 4) provides Dynamic Host Configuration Protocol (DHCP) binding for a dynamically configured laptop 20 (FIG. 1).

Referring to FIGS. 1 through 5, when hotel 14 is being wired, the installer creates a list of room 12 addresses and the respective wiring address information for the room 12. This information is fed into NAT table 184 through either a tool (e.g., an identification frame injected into room gateway 28 at the time of the installation) or through entering the data manually into the smart router 50. Preferably, data can be entered into NAT table 184 though an information server 64 and then exported to smart router 50 via LAN 63.

The smart router 50 complements NAT table 184 with dynamic data. The SNMP agent process 280 in smart router 50 queries room hubs 16 with SNMP messages. The room hubs 16 respond with the MAC and IP addresses of devices 18 and room gateways 28 that are connected to their respective ports. The SNMP agent process 280 frequently polls the found devices 18 and room gateways 28 to monitor their presence—deriving from it a present/lost status, which is input into NAT table 184. Information servers 64 and remote server 84 periodically access NAT table 184 using NAT management process 268 in smart router 50 to ensure that their copy of NAT table 184 is up to date. Information servers 64 and remote server 84 can then use the data NAT table 184 to address data to any individual device 18 or 30 in room 12.

Centralized guest room control system 10 provides high speed Internet access, sophisticated energy management, direct digital control, digital video-on-demand, minibar reporting, Voice over Internet Protocol (VoIP) phones, central electronic lock control, and a myriad of other services to the hotel and resort owner. Centralized guest room control system 10 provides these services to each room through a single wire, rather than the large number of wires previously associated with guest room control systems. Accordingly, centralized guest room control system 10 reduces installation and maintenance costs from those previously attainable using guest room services of the prior art. In addition, guest room control system 10 supports applications that depend on faster, unconditional links, such as digital video or a centralized locking system.

Centralized guest room system 10 allows a single user at a remote server to control any number of hotels or guest rooms. Because the smart router, switches, and hubs are fully controllable from a remote location, centralized guest room control system 10 allows for remote diagnostics, restarts, and software downloads. Moreover, centralized guest room control system 10 allows any number of rooms to be aggregated into a single power consumer. As a single power consumer, the operator of centralized guest room system 10 can negotiate with electric utility companies for better power rates in exchange for promising to lower power consumption during peak demand times.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of providing guest room services and guest room control in a building including a plurality of guest rooms, the method comprising:
storing in memory a plurality of addresses corresponding to a plurality of guest room control devices, each guest room control device in said plurality of guest room control devices is a centralized electronic locking system component, a guest room energy management system component, a direct digital control system component, a minibar monitoring device, or a combination comprising at least one of the foregoing guest room control devices;
selecting an address of a guest room control device from said plurality of addresses;
encapsulating data in a first packet configured according to a packet switching protocol;
indicating in said packet said address of said guest room control device; and
sending said first packet to said guest room control device through a network.

2. The method of claim 1, further comprising:
sending a second packet configured according to said packet switching protocol to a guest room service device through said network, said guest room service device is a computer, a voice over Internet Protocol phone, an Internet Protocol radio, a television signal converter, or a combination comprising at least one of the foregoing guest room service devices.

3. The method of claim 1, further comprising:
storing in memory a plurality of medium access control addresses for room gateways located in said plurality of guest rooms;
selecting a medium access control address of a room gateway associated with said guest room control device from said plurality of medium access control addresses; and
indicating in said packet said medium access control address of said room gateway prior to said sending.

4. The method of claim 1, further including:
selecting an address of a second guest room control device from said plurality of addresses;
encapsulating a copy of said data in a second packet configured according to said packet switching protocol;
indicating in said second packet said address of said second guest room control device; and
sending said second packet to said second guest room control device through said network.

5. The method of claim 4, wherein said data indicates an energy demand situation.

6. The method of claim 1, wherein said first packet is provided by a property management system server.

7. The method of claim 1, wherein said packet switching protocol is selected from a group including TCP/IP and UDP/IP.

8. The method of claim 1, further comprising:
encapsulating data provided by said guest room control device in a second packet configured according to said packet switching protocol.

9. A smart router for a guest room control system, the smart router comprising:
a first port configured to be in operable communication with a computer network;
at least one processor in operable communication with said first port;
at least one memory device in operable communication with said at least one processor, said at least one memory device includes a network address table stored therein, said network address table indicates an address for a guest room control device in operable communication with said computer network, said guest room control device is a centralized electronic locking system component, a guest room energy management system component, a direct digital control system component, a minibar monitoring device, or a combination comprising at least one of the foregoing guest room control devices; and
wherein said at least one processor encapsulates data in a first packet configured according to a first packet switching protocol and outputs said first packet to said first port, said first packet indicates said address for said memory device.

10. The smart router of claim 9, further comprising:
a second port in operable communication with said at least one processor; and
wherein said at least one processor receives a second packet configured according to a second packet switching protocol from said second port, said at least one processor extracts said data from said second packet.

11. The smart router of claim 10, wherein said data indicates an energy demand situation.

12. The smart router of claim 11, wherein said at least one processor encapsulates said data in a plurality of packets addressed to a plurality of different guest room control devices in operable communication with said secondary network and provides said plurality of packets to said first port.

13. The smart router of claim 12 wherein said first and second packet switching protocols are TCP/IP.

14. The smart router of claim 12 wherein said first packet switching protocol is UDP/IP and said second packet switching protocol is TCP/IP.

15. The smart router of claim 9, wherein said at least one processor receives a second packet configured according to said first packet switching protocol from said first port, said at least one processor stores data from said second packet in said at least one memory device.

16. The smart router of claim 15, wherein said at least one processor encapsulates said data from said second packet into a third packet configured according to a second packet switching protocol, said at least one processor provides said second packet to said second port.

17. The smart router of claim 16, wherein said first and second packet switching protocols are TCP/IP.

18. The smart router of claim 16, wherein said first packet switching protocol is UDP/IP and said second packet switching protocol is TCP/IP.

19. The smart router of claim 9, further including:
a third port configured to connect with a property management system server.

20. The smart router of claim 9, further including:
a fourth port configured to connect with a modem, said at least one processor outputs a first plurality of signals to said second port.

21. The smart router of claim 9, further including:
a fifth port configured to connect with a portion of a legacy guest room control system;
a sixth port configured to connect with a portion of a legacy guest room control system; and
wherein said at least one processor transfers data configured according to a network layer protocol between said fifth port and said sixth port.

22. The smart router of claim 9 wherein said at least one processor includes:
a first processor in operable communication with said first port, and
a second processor in operable communication with said second port, said first processor is in operable communication with said second processor; and
wherein said at least one memory device includes:
a first memory device in operable communication said first processor, and
a second memory device in operable communication with said second processor.
